(19) United States
(12) Patent Application Publication
(10) Pub. No.: US 2021/0165239 A1
(43) Pub. Date: Jun. 3, 2021

(54) Optical Member Driving Device, Camera Device and Electronic Apparatus

(71) Applicant: New Shicoh Motor Co. Ltd., Zhejiang (CN)

(72) Inventor: Wade TATSUKI, Zhejiang (CN)

(21) Appl. No.: 17/104,618

(22) Filed: Nov. 25, 2020

(30) Foreign Application Priority Data
Dec. 3, 2019 (CN) 201911220580.4
Dec. 3, 2019 (CN) 201911221781.6

(51) Int. Cl. G02B 27/64; H04N 5/225

(52) U.S. Cl. CPC G02B 27/646; G02B 7/09; H04N 5/2253

(57) ABSTRACT

An optical member driving device is described that includes a base, an FPC, a lower crimp plate, an upper crimp plate and a plurality of SMA wires. The FPC is fixed on the base. The lower crimp plate is fixed on the FPC. The upper crimp plate slides on the lower crimp plate. The plurality of SMA wires are fixed to the lower crimp plate and the upper crimp plate at both ends. The lower crimp plate includes a plurality of plate pieces having one crimp portion, and each of the plate pieces is fixed on the FPC in a state of being separated from each other and is electrically connected to the FPC.

### CROSS-REFERENCE TO RELATED APPLICATION

This application claims the benefit of Chinese patent applications CN201911221781.6 and CN201911220580.4, each filed on Dec. 3, 2019, the contents of which are incorporated by reference herein.

### TECHNICAL FIELD

The present disclosure relates to an optical member driving device used in electronic apparatus such as smartphones, a camera device, and an electronic apparatus.

### BACKGROUND

In a camera device equipped with an OIS (Optical Image Stabilizer) function, a SMA (Shape Memory Alloy) wire is provided between a movable member that holds the optical member and a support member that supports the movable member. By the expansion and contraction of the SMA wire, the movable member and the support member are relatively moved. As a document disclosing a technique related to this type of camera device, International Publication WO2018/129185A (hereinafter referred to as “Patent Document 1”) can be given. The suspension assembly described in Patent Document 1 includes a movable member which is a plate body made of stainless steel, and a support member which is a plate body having a wiring portion made of FPC (Flexible Printed Circuits)provided on the base. The movable member and the support member are arranged so as to face each other with a bearing sandwiched therebetween, and have crimp portions at corners in the diagonal direction of the support member and corners in the diagonal direction of the movable member which intersects the diagonal direction of the support member. An SMA wire is laid between the crimp portion of the movable member and the crimp portion of the support member.

### SUMMARY

However, in the technique of Patent Document 1, the wiring portion on the base of the support member extends to the crimp portion at the corner, and at the crimp portion, the constitution is adopted in which the SMA wire is crimped together with the wiring portion to fix the SMA wire. Therefore, there is a problem that the fixing strength of the SMA wire is weak.

The present disclosure has been made in view of such a problem, and one of objects of the present disclosure is to provide an optical member driving device, a camera device, and an electronic apparatus, in which an SMA wire can be fixed with sufficient strength.

In accordance with a first aspect of the present disclosure, there is provided an optical member driving device including: a base; an FPC fixed on the base; a lower crimp plate fixed on the FPC; an upper crimp plate sliding on the lower crimp plate; and a plurality of SMA wires fixed to the lower crimp plate and the upper crimp plate at both ends, wherein the lower crimp plate includes a plurality of plate pieces having one crimp portion, and each of the plate pieces is fixed on the FPC in separation from each other and is electrically connected to the FPC.

In accordance with a second aspect of the present disclosure, there is provided a camera device including the optical member driving device described above.

In accordance with a third aspect of the present disclosure, there is provided an electronic apparatus comprising the camera device described above.

### DESCRIPTION OF DRAWINGS

FIG. 1 is a front view of a smartphone which is an electronic apparatus mounted with a camera device including an OIS lens driving device which is an optical member driving device, according to one embodiment of the present disclosure;

FIG. 2 is a perspective view of the camera device of FIG. 1;

FIG. 3 is a perspective view of the OIS lens driving device of FIG. 2;

FIG. 4 is an exploded perspective view of the OIS lens driving device of FIG. 2;

FIG. 5A is a view of a portion of the upper crimp plate 5 of the OIS lens driving device of FIG. 2 as viewed from an oblique lower side;

FIG. 5B is a cross-sectional view of abutting portions of the protruding portion of the upper crimp plate and the third plate piece of the lower crimp plate; and

FIG. 5C is a view of portions of the upper crimp plate and the lower crimp plate as viewed from an oblique upper side.

### DETAILED DESCRIPTION

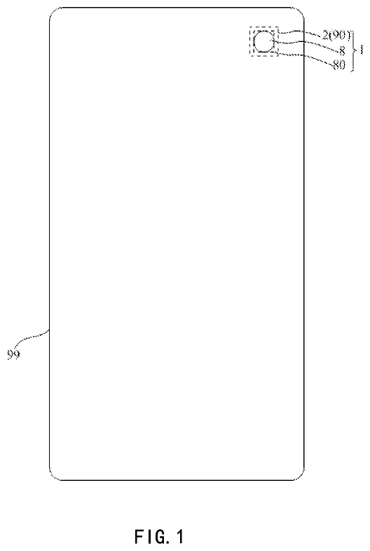

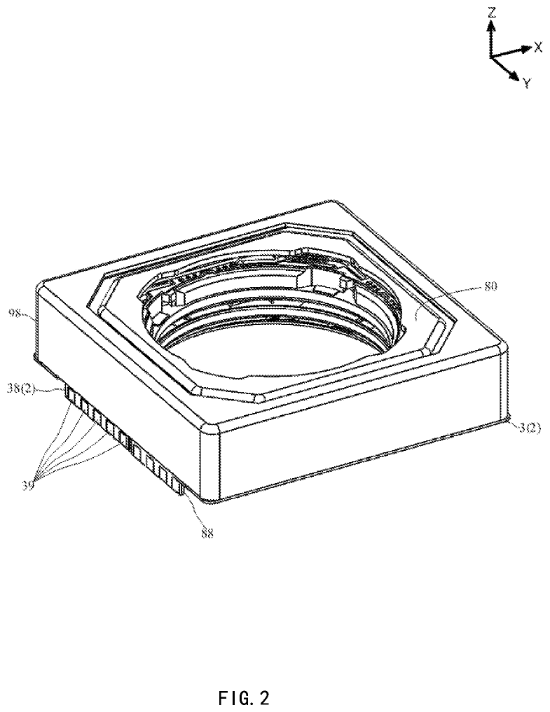

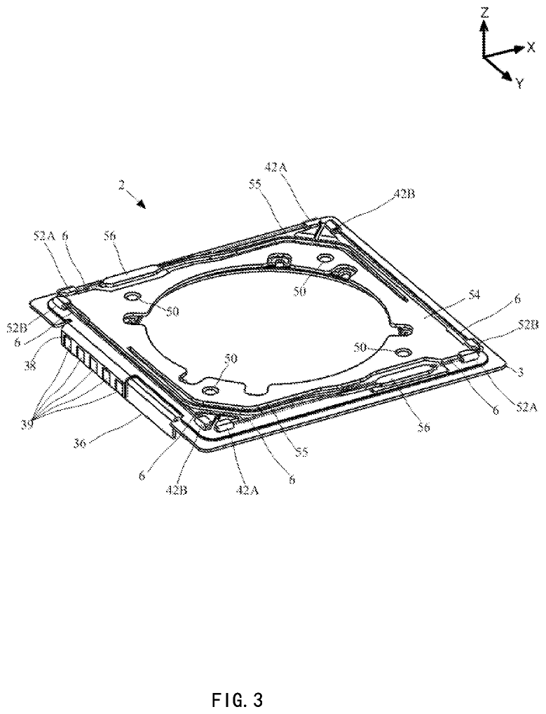

Hereinafter, embodiments of the present disclosure are explained with reference to drawings. As shown in FIG. 1, the camera device 1 is accommodated in the housing of the smartphone 99. The camera device 1 includes: a lens body 8 which is an optical member; an image sensor 90 that photoelectrically converts light incident from a subject via the lens body 8; an AF (Autofocus) actuator 80 that drives the lens body 8 in a direction along an optical axis; an OIS lens driving device 2 that drives the AF actuator 80 in a plane orthogonal to the optical axis; and a case 98 that covers these members. The lens body 8, which is an optical member, is driven by the OIS lens driving device 2 in an in-plane direction orthogonal to the optical axis.

Hereinafter, the optical axis direction along the optical axis of the lens body 8 is appropriately referred to as a Z direction, one direction orthogonal to the Z direction is appropriately referred to as an X direction and a direction orthogonal to both the Z direction and the X direction is appropriately referred to as a Y direction. Further, the +Z side of the optical axis of the lens body 8, which is the side of the subject, may be referred to as an upper side, and the −Z side, which is the side on which the image sensor 90 on the opposite side of the subject is provided, may be referred to as a lower side.

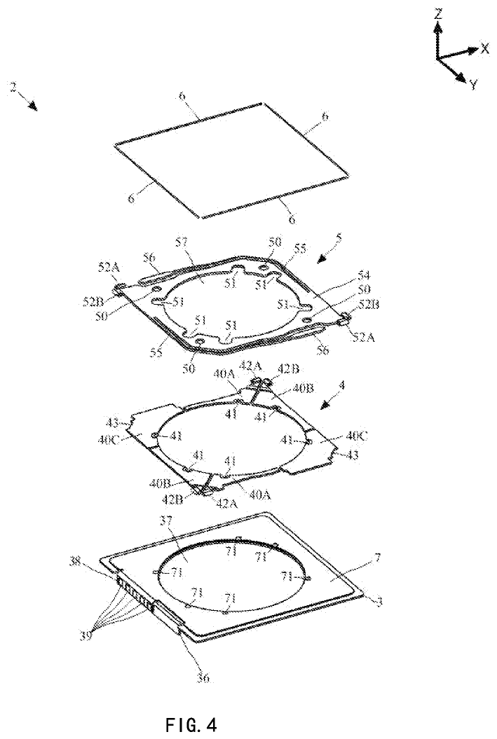

As shown in FIG. 4, the OIS lens driving device 2 includes a base 3, a lower crimp plate 4 fixed on the base 3, an upper crimp plate 5 sliding on the lower crimp plate 4, and four SMA wires 6 fixed to the lower crimp plate 4 and the upper crimp plate 5 at both ends. The details of the configuration of each portion will be described below.

The base 3 has a thin rectangular shape. A perfect circle-shaped through hole 37 is provided in the center of the base 3. A supporting piece 36 and a terminal block 38 are provided on an end side of the base 3 on the −X side. The supporting piece 36 is used to support the terminal block 88 of the AF actuator 80 from the back side. The AF actuator 80 and the terminal block 88 are connected by the FPC. The terminal block 38 of the base 3 is provided with five terminals 39. One of the five terminals 39 is a grounding terminal. The remaining four are current input terminals.

The FPC 7 is fixed to the upper surface of the base 3. Lands 71 are provided at six locations on the periphery of the through hole 37 in the FPC 7. The FPC 7 is a circuit board having wiring from each land 71 to each terminal 39.

The lower crimp plate 4 is formed by arranging a pair of first plate pieces 40A, a pair of second plate pieces 40B and a pair of third plate pieces 40C having arc-shaped curved sides, respectively, so as to form a substantially square shape as a whole with each curved side facing inward. The first plate pieces 40A, the second plate pieces 40B, and the third plate pieces 40C are made of, for example, a conductive material such as SUS. The first plate pieces 40A, the second plate pieces 40B, and the third plate pieces 40C are fixed on the FPC 7 in a state of being separated from each other.

Each pair of the first plate pieces 40A, the second plate pieces 40B, and the third plate pieces 40C are arranged at point-symmetrical positions about the center of the through hole 37. The first plate pieces 40A and the second plate pieces 40B are located at positions on both sides across one diagonal line of the lower crimp plate 4 forming an approximately square shape, and the third plate pieces 40C are located so as to face each other across the other diagonal line of the approximately square shape that is sandwiched between the first plate pieces 40A and the second plate pieces 40B.

A notch 41 is provided on the curved side of the first plate piece 40A, and a crimp portion 42A is provided at a position of the corner portion of the approximately square shape. The crimp portion 42A is formed by bending a rectangular piece, which protrudes outward in the Y direction with the corner portion as a base end, upward, and then folding the rectangular piece back to the side of the base end. A step is provided between the crimp portion 42A and the curved side by bending the first plate piece 40A so as to obtain a same height as that of a crimp portion 52A of an upper crimp plate 5 to be described later.

A notch 41 is provided on the curved side of the second plate piece 40B, and a crimp portion 42B is provided at a position of the corner portion of the approximately square shape. The crimp portion 42B is formed by bending a rectangular piece, which protrudes outward in the X direction with the corner portion as a base end, upward, and then folding the rectangular piece back to the side of the base end. A step is provided between the crimp portion 42B and the curved side by bending the second plate piece 40B so as to obtain a same height as that of a crimp portion 52B of an upper crimp plate 5 to be described later.

A notch 41 is provided on the curved side of the third plate piece 40C, and a notch 43 is provided at a corner portion where the two sides opposite to the curved side intersect.

The first plate pieces 40A, the second plate pieces 40B, and the third plate pieces 40C are positioned so that their notches 41 are directly above the lands 71 of the FPC 7, and are soldered directly to the lands 71 of the FPC 7. Two first plate pieces 40A and two second plate pieces 40B are respectively electrically connected to the current input terminals of five terminals 39 of the terminal block 38 via the wiring of the FPC 7. Two third plate pieces 40C are electrically connected to one grounding terminal of five terminals 39 of the terminal block38 via the wiring of the FPC 7.

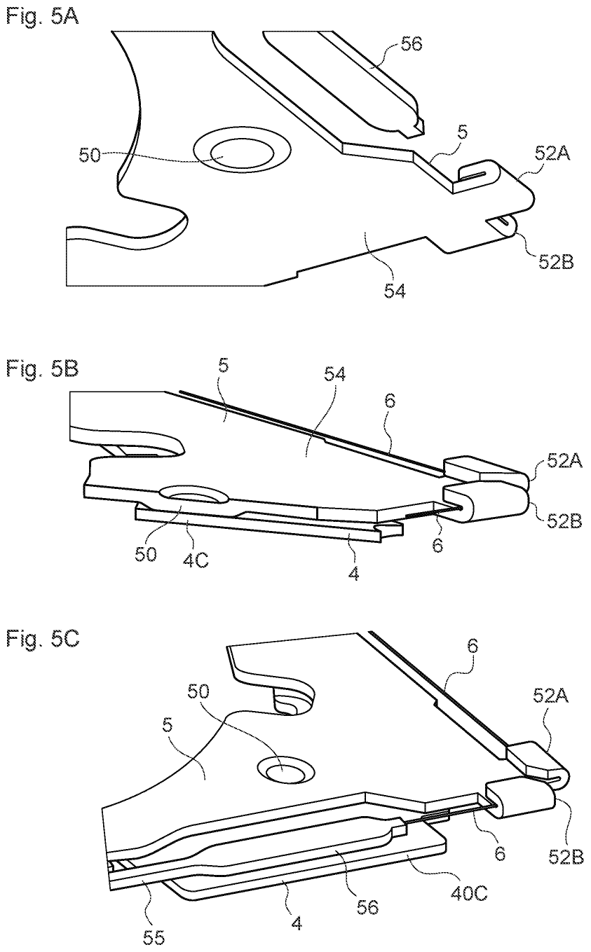

The upper crimp plate 5 is made of, for example, a conductive material such as SUS, and has a main body portion 54 in an approximately square shape and two aim portions 55 extending outward in a point-symmetrical manner from two end sides of the main body portion 54 parallel to the Y direction. A through hole 57 is provided in the center of the main body portion 54. Notches 51 are provided at six locations on the periphery of the through hole 57 in the main body portion 54. Protruding portions 50 protruding downward are provided at four locations on the periphery of the through hole 57 in the main body portion 54. As shown in FIG. 5A, the protruding portion 50 protrudes smoothly from the main body portion 54 and the lower surface portion thereof has a circular flat plate shape. Since the protruding portion 50 can be integrally formed with the upper crimp plate 5 by a press or the like, it is also excellent in impact resistance such as dropping.

The corner portions of the upper crimp plate 5 facing each other across one diagonal line are chamfered and rounded and the corner portions facing each other across the other diagonal line are provided with two crimp portions 52A and 52B respectively. The crimp portion 52A is formed by bending a rectangular piece, which protrudes outward in the Y direction with the corner portion as a base end, upward, and then folding the rectangular piece back to the side of the base end. The crimp portion 52B is formed by bending a rectangular piece, which protrudes outward in the X direction with the corner portion as a base end, upward, and then folding the rectangular piece back to the side of the base end.

The aim portion 55 protrudes in the Y direction from the base end at a position close to a corner portion with the crimp portion 52B on the end side of the main body portion 54 parallel to the Y direction, extends along the end side of the Y direction up to the corner portion on the side without the crimp portion 52B, turns around the outer side of the corner portion, and extends to the front of the crimp portion 52A along the end side of the X direction. The tip end of the arm portion 55 is provided with a connection portion 56. Two of the protruding portions 50 are provided at positions close to the connection portion 56 in the main body portion 54.

The lower crimp plate 4 and the upper crimp plate 5 are placed on the base 3 in this order in such a manner that the approximately square-shaped corner portions thereof overlap the approximately square-shaped corner portions of the base 3. The crimp portions 42A and 42B of the lower crimp plate 4 are arranged at corner portions in the direction of one diagonal line of the approximately square shape, and the crimp portions 52A and 52B of the upper crimp plate 5 are arranged at corner portions in the direction of the other diagonal line of the approximately square shape. At this time, the crimp portion 42A and the crimp portion 52A are lined up in the X direction, and the crimp portion 42B and the crimp portion 52B are lined up in the Y direction. Further, the aim portion 55 is arranged between the chamfered corner portion of the main body portion 54 and the step formed on the first plate piece 40A and the second plate piece 40B. Further, the notch 51 of the upper crimp plate 5 is positioned directly above the notch 41 of the lower crimp plate 4, so that the solder does not come into contact with the upper crimp plate 5.

As shown in FIG. 5B, two of the four protruding portions 50 of the upper crimp plate 5 abut against the abutted portions of the third plate pieces 40C of the lower crimp plate 4. The remaining two of the protruding portions 50 abut against the abutted portions of the second plate pieces 40B. A low friction layer is formed on the surfaces of the protruding portions 50, and an insulating layer is formed on the surfaces of the abutted portions of the third plate pieces 40C and the second plate pieces 40B against which the protruding portions 50 abut. It is to be noted that, a low friction layer may be formed on the surfaces of the abutted portions of the third plate pieces 40C and the second plate pieces 40B, and an insulating layer may be formed on the surfaces of the protruding portions 50. Further, the lower crimp plate 4 may be provided with protruding portions, and the upper crimp plate 5 may be provided with the abutted portions.

It will be described in more detail. When the upper crimp plate 5 is provided with one of the protruding portion 50 and the abutted portion, and the first plate piece 40A or the second plate piece 40B of the lower crimp plate 4 is provided with the other of the protruding portion and the abutted portion, as can be seen from the description described later, there is a potential difference between the upper crimp plate 5 and the lower crimp plate 4. Therefore, at least one of the surface of the protruding portion and the surface of the abutted portion is provided with the insulating layer, and the two are insulated from each other. Then, it is preferable that the frictional coefficient between the two is small, and it is desirable that a low friction layer with a small friction coefficient is provided on the surface thereof, that is, on the surface of the protruding portion or the surface of the abutted portion without the insulating layer, or the surface of the insulating layer.

When the upper crimp plate 5 is provided with one of the protruding portion 50 or the abutted portion, and the third plate piece 40C of the lower crimp plate 4 is provided with the other of the protruding portion or the abutted portion, as can be seen from the description described later, the upper crimp plate 5 and the lower crimp plate 4 have the same potential. Therefore, it is not necessary to provide an insulating layer, and the protruding portion and the abutted portion may abut against each other directly. Further, the layer described in the previous paragraph may be provided, or the insulating layer may not be provided and only the low friction layer may be provided.

As shown in FIG. 5C, the connection portion 56 of the upper crimp plate 5 is joined to the upper surface of the third plate piece 40C and electrically connected to the third plate piece 40C. Further, both ends of two SMA wires 6 extending in the X direction are crimped and fixed to the crimp portions 42A and the crimp portions 52A, respectively, and both ends of two SMA wires 6 extending in the Y direction are crimped and fixed to the crimp portions 42B and the crimp portions 52B, respectively.

Five terminals 39 of the terminal block38 are connected to an external power source. Thereby, a current path of the external power source→the current input terminal→the wiring of the FPC 7→the first plate pieces 40A or the second plate pieces 40B of the lower crimp plate 4→the SMA wires 6→the upper crimp plate 5→the third plate pieces 40C of the lower crimp plate 4→the wiring of the FPC 7→the grounding terminal→the external power source is formed, and a current is supplied to the SMA wires 6. When a current is supplied to the SMA wires 6, the SMA wires 6 respectively contract due to heat generated by the electricity supply. Due to the contraction of the SMA wires 6, the upper crimp plate 5 and the AF actuator 80 supported by the upper crimp plate 5 move in the in-plane direction of XY while sliding on the lower crimp plate 4.

The above is the details of the configuration of the present embodiment. The OIS lens driving device 2, which is the optical member driving device of the present embodiment, includes the base 3, the FPC 7 fixed on the base 3, the lower crimp plate 4 fixed on the FPC 7, the upper crimp plate 5 sliding on the lower crimp plate 4, and a plurality of SMA wires 6 fixed to the lower crimp plate 4 and the upper crimp plate 5 at both ends. Further, the lower crimp plate 4 includes the first plate pieces 40A and the second plate pieces 40B, which are a plurality of plate pieces having one crimp portion, and each of the plate pieces is fixed on the FPC 7 in a state being separated from each other and is electrically connected to the FPC. Accordingly, as long as individual wiring is provided on the FPC 7 from each of the plate pieces to the terminal 39 connected to the external power source, it is not necessary to provide wiring on each of the plate pieces itself. Therefore, the SMA wire 6 can be directly crimped at the crimp portion without crimping the SMA wire 6 together with the wiring portion. For that reason, according to the present embodiment, it is possible to provide an optical member driving device, a camera device, and an electronic apparatus, in which the SMA wire 6 can be fixed with sufficient strength.

Further, in the OIS lens driving device 2 which is the optical member driving device of the present embodiment, the lower crimp plate 4 has a third plate piece 40C which is a plate piece without crimp portion, and an aim portion 55 extending from the main body portion 54 of the upper crimp plate 5 is electrically connected to the third plate piece 40C. Accordingly, as long as individual wiring is provided on the FPC 7 from the third plate piece 40C to the terminal 39 for grounding, it is not necessary to provide wiring to the third plate piece 40C itself. Therefore, according to the present embodiment, all electrical connections can be realized with the same configuration, and manufacturing is easy.

Further, in the OIS lens driving device 2 which is the optical member driving device of the present embodiment, the upper crimp plate 5 which is one of the lower crimp plate 4 and the upper crimp plate 5 has a protruding portion 50 protruding toward the lower crimp plate 4 which is the other of the lower crimp plate 4 and the upper crimp plate 5, and abuts against the abutted portion provided on the other of the lower crimp plate 4 and the upper crimp plate 5. Thus, according to the present embodiment, since it is not necessary to fix a plurality of very small parts, the OIS lens driving device 2, which is the optical member driving device of the present embodiment, is highly reliable and easy to manufacture. Therefore, according to the present embodiment, it is possible to provide an optical member driving device, a camera device, and an electronic apparatus that are highly reliable and easy to manufacture.

It is to be noted that in the above embodiment, it is not necessary to make each plate piece forming the lower crimp plate 4 by individual press working. All of the plate pieces forming the lower crimp plate 4 may be integrated by press working, fixed to the FPC 7, and then the connecting portion of each plate piece may be cut.

It is to be noted that a metal layer suitable for sliding may be provided on the surface of the insulating layer provided on the surface of the protruding portion or the surface of the abutted portion. Further, instead of providing the insulating layer and the low friction layer separately, a layer that serves as both the insulating layer and the low friction layer may be provided. Further, in FIG. 4 and FIG. 5, the abutted portion is not marked and has the same height as those of the surroundings thereof, but it may be provided higher or lower than the surroundings thereof.

What is claimed is:

1. An optical member driving device, comprising:
a base;
an FPC fixed on the base;
a lower crimp plate fixed on the FPC;
an upper crimp plate sliding on the lower crimp plate; and
a plurality of SMA wires fixed to the lower crimp plate and the upper crimp plate at both ends,
wherein the lower crimp plate comprises a plurality of plate pieces with one crimp portion, and each of the plate pieces is fixed on the FPC in separation from each other and is electrically connected to the FPC.

2. The optical member driving device according to claim 1, wherein the lower crimp plate comprises a plate piece with no crimp portion, and an aim portion extending from a main body portion of the upper crimp plate is electrically connected to the plate piece.

3. The optical member driving device according to claim 2, wherein each of the plate pieces is directly soldered to a land provided on a surface of the FPC.

4. The optical member driving device according to claim 1, wherein one of the lower crimp plate and the upper crimp plate comprises a protruding portion protruding toward the other of the lower crimp plate and the upper crimp plate and abuts against an abutted portion provided on the other of the lower crimp plate and the upper crimp plate.

5. The optical member driving device according to claim 4, wherein a surface of the protruding portion or a surface of the abutted portion is provided with an insulating layer.

6. The optical member driving device according to claim 5, wherein a low friction layer is provided on the surface of the protruding portion or the surface of the abutted portion where no insulating layer is provided, or on a surface of the insulating layer.

7. The optical member driving device according to claim 5, wherein a metal layer is provided on the surface of the insulating layer.

8. The optical member driving device according to claim 4, wherein the protruding portion and the abutted portion have a same potential.

9. The optical member driving device according to claim 4, wherein a FPC fixing the lower crimp plate on an upper side is fixed to the base.

10. A camera device comprising the optical member driving device according to claim 1.

11. An electronic apparatus comprising the camera device according to claim 10.
